(19) United States
(12) Patent Application Publication
(10) Pub. No.: US 2024/0002600 A1
(43) Pub. Date: Jan. 4, 2024

(54) POLYAMIC ACID COMPOSITION, AND POLYIMIDE COMPRISING SAME

(71) Applicant: PI ADVANCED MATERIALS CO., LTD., Chungcheongbuk-do (KR)

(72) Inventors: In Hwan HWANG, Seoul (KR); Ik Sang LEE, Gyeongsangbuk-do (KR)

(21) Appl. No.: 18/037,862

(22) PCT Filed: Nov. 27, 2020
(86) PCT No.: PCT/KR2020/017148

§ 371 Date: May 19, 2023

(30) Foreign Application Priority Data
Nov. 19, 2020 (KR) 1020200155540

(51) Int. Cl. C08G 73/10; C08K 3/36; C08J 5/18

(52) U.S. Cl. CPC C08G 73/1067; C08J 5/18; C08K 3/36; C08G 73/1032

(57) ABSTRACT

The present application relates to a polyamic acid composition and a polyimide comprising same, and provides a polyamic acid composition which has a high concentration of polyamic acid solids and a low viscosity and, after hardening, has superior heat resistance, dimensional stability, and mechanical properties, and a polyimide and a polyimide film produced therefrom.

### TECHNICAL FIELD

### Cross-Reference to Related Application

This application claims the benefit of Korean Patent Application No. 10-2020-0155540, filed on Nov. 19, 2020 in the Korean Intellectual Property Office, the disclosure of which is incorporated herein by reference.

The present application relates to a polyamic acid composition and a polyimide including the same.

### BACKGROUND ART

A polyimide (PI) is a polymer material with thermal stability based on a rigid aromatic main chain, and has excellent mechanical properties such as strength, chemical resistance, weather resistance, and heat resistance based on the chemical stability of an imide ring.

In addition, polyimides are attracting attention as high-functional polymer materials applicable to a wide range of industrial fields such as electronics, communication, and optics due to their excellent electrical properties such as insulation and a low dielectric constant.

Recently, as various electronic devices have become thinner, lighter, and smaller, there have been many studies on using a thin polyimide film, which is lightweight and has excellent flexibility, as a display substrate capable of replacing an insulating material of a circuit board or a glass substrate for a display.

In particular, in the case of a polyimide film used for a circuit board or display substrate manufactured at a high process temperature, it is necessary to secure higher levels of dimensional stability, heat resistance, and mechanical properties.

As one method of securing such physical properties, a method of increasing a molecular weight of a polyimide may be exemplified.

Since a polyimide film has better heat resistance and mechanical properties when the molecule has more imide groups, and a longer polymer chain results in a higher ratio of imide groups, preparing a polyimide having a high molecular weight is advantageous for securing physical properties.

In order to manufacture a high molecular weight polyimide, it is common to imidize a polyamic acid, which is a precursor, through heat treatment after preparing the polyamic acid with a high molecular weight.

However, as the molecular weight of the polyamic acid increases, the viscosity of the polyamic acid solution in which the polyamic acid is dissolved in a solvent increases, resulting in a decrease in fluidity and very low process handling properties.

In addition, in order to lower the viscosity of the polyamic acid while maintaining the molecular weight of the polyamic acid, a method of lowering the solid content and increasing the solvent content may be considered, but in this case, as a large amount of solvent needs to be removed during a curing process, problems of increasing manufacturing cost and processing time may occur.

Therefore, there is a high need for research on a polyimide film that satisfies processability by maintaining a low viscosity even when the solid content of the polyamic acid solution is high, and simultaneously satisfies heat resistance and

mechanical properties of the polyimide prepared therefrom.

### DISCLOSURE

### Technical Problem

The present application is directed to providing a polyamic acid composition which has a high solid content of polyamic acid, low viscosity, and excellent heat resistance, dimensional stability, and mechanical properties after curing, and a polyimide and a polyimide film prepared therefrom.

### Technical Solution

The present application relates to a polyamic acid composition. The polyamic acid composition according to the present application may include a polyamic acid including a dianhydride monomer component and a diamine monomer component as polymerization units. In addition, the polyamic acid composition may include an organic solvent including a first solvent and a second solvent. The second solvent may have at least one polar functional group selected from the group consisting of a hydroxyl group, a carboxyl group, an alkoxy group, an ester group, and an ether group. The first solvent may be a different component from the second solvent. The present application can provide a polyamic acid composition with desired physical properties by including a first solvent and a second solvent that are different components and limiting the type of a functional group of the second solvent.

In one embodiment, the dianhydride monomer may include a monomer having an unpolymerized ring-opened structure in addition to the monomer included in the polymerization unit. That is, some of the dianhydride monomers may be included in the polymerization unit, and some may not be included in the polymerization unit, and the dianhydride monomer not included in the polymerization unit may have a ring-opened structure by the organic solvent according to the present application. The polyamic acid composition according to the present application may exist in the form of an aromatic carboxylic acid having two or more carboxylic acids in a state in which the dianhydride monomer is not polymerized, and the aromatic carboxylic acid may be present as a monomer before curing to lower the viscosity of an entire polyamic acid composition and improve processability. The aromatic carboxylic acid having the two or more carboxylic acids is polymerized into a dianhydride monomer in a main chain after curing, thereby increasing an overall polymer chain length, and such a polymer can realize excellent heat resistance, dimensional stability, and mechanical properties.

Specifically, when the polyamic acid composition is subjected to heat treatment for imidization into a polyimide, the aromatic carboxylic acid having two or more carboxylic acids can react with a terminal amine group of a polyamic acid chain or a polyimide chain by becoming dianhydride monomers through a closed-ring dehydration reaction, thereby increasing the polymer chain length, which can improve the dimensional stability and thermal stability at high temperatures of a prepared polyimide film, and improve the mechanical properties at room temperature.

In one example, as described above, the polyamic acid composition of the present application may include a second solvent, and the second solvent may be included in an amount of 0.01% by weight to 10% by weight in the entire polyamic acid composition. A lower limit of the content of the second solvent may be, for example, 0.015% by weight, 0.03% by weight, 0.05% by weight, 0.08% by weight, 0.1% by weight, 0.3% by weight, 0.5% by weight, 0.8% by weight, 1% by weight, or 2% by weight or more, and an upper limit may be, for example, 10% by weight, 9% by weight, 8% by weight, 7% by weight, 6% by weight, 5.5% by weight, 5.3% by weight, 5% by weight, 4.8% by weight, 4.5% by weight, 4% by weight, 3% by weight, 2.5% by weight, 1.5% by weight, 1.2% by weight, 0.95% by weight, or 0.4% by weight or less. In addition, the first solvent may be included in an amount of 60 to 95% by weight in the entire polyamic acid composition. A lower limit of the content of the first solvent may be, for example, 65% by weight, 68% by weight, 70% by weight, 73% by weight, 75% by weight, 78% by weight, or 80% by weight or more, and an upper limit may be, for example, 93% by weight, 90% by weight, 88% by weight, 85% by weight, 83% by weight, 81% by weight, or 79% by weight or less. The polyamic acid composition according to the present application includes a dianhydride monomer component and a diamine monomer component, wherein the two monomers constitute a polymerization unit with each other, but some of the dianhydride monomers are ring-opened by the organic solvent, so that they cannot participate in the polymerization reaction. An unpolymerized ring-opened dianhydride monomer acts as a diluting monomer, and can control the viscosity of the entire polyamic acid composition to be relatively low. The dianhydride monomer having the ring-opened structure may participate in the imidation reaction to realize a desired polyimide.

As described above, the polyamic acid composition of the present application may include a diamine monomer and a dianhydride monomer as polymerization units. In the present specification, “polyimide precursor composition” may be used with the same meaning as “polyamic acid composition” or “polyamic acid solution.”

The dianhydride monomer that can be used in the preparation of the polyamic acid solution may be an aromatic tetracarboxylic dianhydride, and the aromatic tetracarboxylic dianhydride may be pyromellitic dianhydride (or PMDA), 3,3′,4,4′-biphenyltetracarboxylic dianhydride (or BPDA), 2,3,3′,4′-biphenyltetracarboxylic dianhydride (or a-BPDA), oxydiphthalic dianhydride (or ODPA), diphenylsulfone-3,4,3′,4′-tetracarboxylic dianhydride (or DSDA), bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenonetetracarboxylic dianhydride, 3,3′,4,4′-benzophenonetetracarboxylic dianhydride (or BTDA), bis(3,4-dicarboxyphenyl)methane dianhydride, 2,2-bis(3,4-dicarboxyphenyl) propane dianhydride, p-phenylenebis(trimellitic monoester acid anhydride), p-biphenylenebis(trimellitic monoester acid anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride (BPADA), 2,3,6,7-naphthalenetetracarboxylic acid dianhydride, 1,4,5,8-naphthalenetetracarboxylic dianhydride or 4,4′-(2,2-hexafluoroisopropylidene)diphthalic acid dianhydride.

The dianhydride monomer may be used alone or in a combination of two or more as needed, and for example, may include pyromellitic dianhydride (PMDA), 3,3′,4,4′-biphenyltetracarboxylic dianhydride (s-BPDA), 2,3,3′,4′-biphenyltetracarboxylic dianhydride (a-BPDA), 3,3′,4,4′-benzophenonetetracarboxylic dianhydride (BTDA), oxydiphthalic dianhydride (ODPA), 4,4-(hexafluoroisopropylidene)diphthalic anhydride (6-FDA), or p-phenylenebis(trimellitate anhydride) (TAHQ).

In an embodiment of the present application, the dianhydride monomer may include a dianhydride monomer having one benzene ring and a dianhydride monomer having two or more benzene rings. The dianhydride monomer having one benzene ring and the dianhydride monomer having two or more benzene rings may be included in molar ratios of 20 to 60 mol % and 40 to 90 mol %; 25 to 55 mol % and 45 to 80 mol %; or 35 to 53 mol % and 48 to 75 mol %, respectively. In the present application, by including the dianhydride monomer, it is possible to implement mechanical properties at a desired level with excellent adhesion.

In addition, the diamine monomer that can be used for preparing the polyamic acid solution is an aromatic diamine, and may be classified as follows.
1) Diamines having one benzene nucleus in their structure, for example a diamine having a relatively rigid structure, such as 1,4-diaminobenzene (or p-phenylenediamine (PDA)), 1,3-diaminobenzene, 2,4-diaminotoluene, 2,6-diaminotoluene, or 3,5-diaminobenzoic acid (or DABA);
2) Diamines having two benzene nuclei in their structure, such as diaminodiphenyl ethers such as 4,4′-diaminodiphenyl ether (or oxydianiline, ODA) and 3,4′-diaminodiphenyl ether, 4,4′-diaminodiphenylmethane (methylenediamine), 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, bis(4-aminophenyl)sulfide, 4,4′-diaminobenzanilide, 3,3′-dichlorobenzidine, 3,3′-dimethylbenzidine (or o-tolidine), 2,2′-dimethylbenzidine (or m-tolidine), 3,3′-dimethoxybenzidine, 2,2′-dimethoxybenzidine, 3,3′-diaminodiphenyl ether, 3,4′-diaminodiphenyl ether, 4,4′-diaminodiphenyl ether, 3,3′-diaminodiphenylsulfide, 3,4′-diaminodiphenylsulfide, 4,4′-diaminodiphenylsulfide, 3,3′-diaminodiphenylsulfone, 3,4′-diaminodiphenylsulfone, 4,4′-dieminodiphenylsulfone, 3,3′-diaminobenzophenone, 4,4′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-dieminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenylsulfoxide, 3,4′-diaminodiphenylsulfoxide, or 4,4′-diaminodiphenylsulfoxide;
3) Diamines having three benzene nuclei in their structure, such as 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene, 1,4-bis(3-aminophenoxy)benzene (or TPE-Q), 1,4-bis(4-aminophenoxy)benzene (or TPE-Q), 1,3-bis(3-aminophenoxy)-4-trifluoromethylbenzene, 3,3′-diamino-4-(4-phenyl) phenoxybenzophenone, 3,3′-diamino-4,4′-di(4-phenylphenoxy)benzophenone, 1,3-bis(3-aminophenylsulfide)benzene, 1,3-bis(4-aminophenylsulfide)benzene, 1,4-bis(4-aminophenylsulfide)benzene, 1,3-bis(3-aminophenylsulfone)benzene, 1,3-bis(4-aminophenylsulfone)benzene, 1,4-bis(4-aminophenylsulfone)benzene, 1,3-bis[2-(4-aminophenyl)isopropyl]benzene, 1,4-bis[2-(3-aminophenyl)isopropyl]benzene, or 1,4-bis[2-(4-aminophenyl)isopropyl]benzene;
4) Diamines having four benzene nuclei in their structure, such as 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane (BAPP), 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, or 2,2-bis[4-(4-aminophenoxy)phenyl]-1,1,1,3,3,3-hexafluoropropane.

In one example, the diamine monomer according to the present application may include 1,4-diaminobenzene (PPD), 1,3-diaminobenzene (MPD), 2,4-diaminotoluene, 2,6-diaminotoluene, 4,4′-diaminodiphenyl ether (ODA), 4,4′-methylenediamine (MDA), 4,4-diaminobenzanilide (4,4-DABA), N,N-bis(4-aminophenyl)benzene-1,4-dicarboxamide (BPTPA), 2,2-dimethylbenzidine (M-TOLIDINE), or 2,2-bis(trifluoromethyl)benzidine (TFDB).

In one specific example, the polyamic acid composition may include 9 to 35% by weight, 10 to 33% by weight, 10 to 30% by weight, 15 to 25% by weight, or 18 to 23% by weight of a solid content, based on the total weight of the polyamic acid composition. The present application controls the viscosity increase while maintaining the physical properties at a desired level after curing by controlling the solid content of the polyamic acid composition to be relatively high, and can prevent the increase in manufacturing cost and process time required to remove a large amount of solvent during the curing process.

The polyamic acid composition of the present application may be a composition having a low viscosity characteristic. The polyamic acid composition of the present application may have a viscosity of 50,000 cP or less, 40,000 cP or less, 30,000 cP or less, 20,000 cP or less, 10,000 cP or less, or 9,000 cP or less, as measured at a temperature of 23° C. and a shear rate of 1 s⁻¹. The lower limit is not particularly limited, but may be 500 cP or more or 1,000 cP or more. The viscosity may be measured, for example, using Rheostress 600 manufactured by Haake GmbH, and may be measured at a shear rate of 1/s, a temperature of 23° C., and a plate gap of 1 mm. The present invention provides a precursor composition having excellent processability by adjusting the viscosity range, so that a film or substrate having desired physical properties can be formed when the film or substrate is formed.

In one embodiment, the polyamic acid composition of the present application may have a weight average molecular weight ranging from 10,000 to 500,000 g/mol, 15,000 to 400,000 g/mol, 18,000 to 300,000 g/mol, 20,000 to 200,000 g/mol, 25,000 to 100,000 g/mol, or 30,000 to 80,000 g/mol after curing. In the present application, the term “weight average molecular weight” means a conversion value for standard polystyrene measured by gel permeation chromatography (GPC).

In the present application, a first solvent and a second solvent may be included. As described above, the solvent having a specific polar functional group can be defined as a second solvent.

In one example, the second solvent may have a solubility of less than 1.5 g/100 g with respect to the dianhydride monomer. That is, the second solvent may have a solubility of less than 1.5 g/100 g with respect to the dianhydride monomer. An upper limit of the solubility range may be, for example, 1.3 g/100 g, 1.2 g/100 g, 1.1 g/100 g, 1.0 g/100 g, 0.9 g/100 g, 0.8 g/100 g, 0.7 g/100 g, 0.6 g/100 g, 0.5 g/100 g, 0.4 g/100 g, 0.3 g/100 g, 0.25 g/100 g, 0.23 g/100 g, 0.21 g/100 g, 0.2 g/100 g, or 0.15 g/100 g or less, and a lower limit may be, for example, 0 g/100 g, 0.01 g/100 g, 0.05 g/100 g, 0.08 g/100 g, 0.09 g/100 g, or 0.15 g/100 g or more. The present application may provide a polyamic acid composition having desired physical properties by including a second solvent having low solubility with respect to a dianhydride monomer included as a polymerization unit or an unpolymerized dianhydride monomer. When the properties measured in the present application are properties that are affected by temperature, they may be measured at room temperature of 23° C., unless otherwise specified.

In an embodiment of the present application, the first solvent may have, for example, a solubility of 1.5 g/100 g or more with respect to the dianhydride monomer. A lower limit of the solubility range may be, for example, 1.6 g/100 g, 1.65 g/100 g, 1.7 g/100 g, 2 g/100 g, 2.5 g/100 g, 5 g/100 g, 10 g/100 g, 30 g/100 g, 45 g/100 g, 50 g/100 g, or 51 g/100 g or more, and an upper limit may be, for example, 80 g/100 g, 70 g/100 g, 60 g/100 g, 55 g/100 g, 53 g/100 g, 48 g/100 g, 25 g/100 g, 10 g/100 g, 5 g/100 g, or 3 g/100 g or less. The first solvent may have higher solubility than the second solvent.

In one example, a boiling point of the first solvent may be 150° C. or higher, and a boiling point of the second solvent may be lower than that of the first solvent. That is, the boiling point of the first solvent may be higher than that of the second solvent. A boiling point of the second solvent may be in a range of 30° C. or more and less than 150° C. A lower limit of the boiling point of the first solvent may be, for example, 155° C., 160° C., 165° C., 170° C., 175° C., 180° C., 185° C., 190° C., 195° C., 200° C., or 201° C. or more, and an upper limit may be, for example, 500° C., 450° C., 300° C., 280° C., 270° C., 250° C., 240° C., 230° C., 220° C., 210° C., or 205° C. or less. A lower limit of the boiling point of the second solvent may be, for example, 35° C., 40° C., 45° C., 50° C., 53° C., 58° C., 60° C., or 63° C. or more, and an upper limit may be, for example, 148° C., 145° C., 130° C., 120° C., 110° C., 105° C., 95° C., 93° C., 88° C., 85° C., 80° C., 75° C., 73° C., 70° C., or 68° C. or less. In the present application, polyimide having desired physical properties can be prepared by using two solvents having different boiling points.

The first solvent according to the present application is not particularly limited as long as it is a solvent capable of dissolving polyamic acid. The first solvent may also be a polar solvent. For example, the first solvent may be an amide solvent such as N,N-dimethylformamide, N,N-dimethylacetamide, or N-methylpyrrolidone. For example, the first solvent may have an amide group or a ketone group in its molecular structure. The first solvent may have a lower polarity than the second solvent.

As one example, the first solvent may be an aprotic polar solvent. The second solvent may be an aprotic polar solvent or a protic polar solvent. Examples of the second solvent may include alcohol-based solvents such as methanol, ethanol, 1-propanol, butyl alcohol, isobutyl alcohol, and 2-propanol; ester-based solvents such as methyl acetate, ethyl acetate, and isopropyl acetate; carboxylic acid solvents such as formic acid, acetic acid, propionic acid, butyric acid, and lactic acid; ether-based solvents such as dimethyl ether, diethyl ether, diisopropyl ether, and dimethoxyethane methyl t-butyl ether; and dimethyl carbonate, metal methacrylate, or propylene glycol monomethyl ether acetic acid.

As described above, in the present application, the first solvent and the second solvent may be included together. In this case, the first solvent may be included in a greater amount than the second solvent. In addition, the second solvent may be included in an amount of 0.01 to 10 parts by weight based on 100 parts by weight of the first solvent. A lower limit of the content ratio may be, for example, 0.02 parts by weight, 0.03 parts by weight, 0.04 parts by weight, 0.1 parts by weight, 0.3 parts by weight, 0.5 parts by weight, 0.8 parts by weight, 1 part by weight, or 2 parts by weight or more, and an upper limit may be, for example, 8 parts by weight, 6 parts by weight, 5 parts by weight, 4.5 parts by weight, 4 parts by weight, 3 parts by weight, 2.5 parts by weight, 1.5 parts by weight, 1.2 parts by weight, 0.95 parts by weight, 0.4 parts by weight, 0.15 parts by weight, or 0.09 parts by weight or less.

The polyamic acid composition according to the present application may further include inorganic particles. The inorganic particles may have, for example, an average particle diameter in the range of 5 to 80 nm, and in specific embodiments, a lower limit may be 8 nm, 10 nm, 15 nm, 18 nm, 20 nm, or 25 nm or less, and an upper limit may be, for example, 70 nm, 60 nm, 55 nm, 48 nm, or 40 nm or less. In the present specification, the average particle diameter may be an average particle diameter measured according to D50 particle size analysis. In the present application, by adjusting the particle size range, compatibility with polyamic acid may be increased, and desired physical properties may be realized after curing.

A type of the inorganic particle is not particularly limited, but examples may include silica, alumina, titanium dioxide, zirconia, yttria, mica, clay, zeolite, chromium oxide, zinc oxide, iron oxide, magnesium oxide, calcium oxide, scandium oxide, or barium oxide. In addition, a surface treatment agent may be included on the surface of the inorganic particles of the present application. The surface treatment agent may include, for example, a silane coupling agent. The silane coupling agent may be one or two or more selected from the group consisting of epoxy-based, amino-based, and thiol-based compounds. Specifically, the epoxy-based compound may include glycidoxypropyl trimethoxysilane (GPTMS), the amino-based compound may include (3-aminopropyl)trimethoxy-silane (APTMS), and the thiol-based compound may include mercapto-propyl-trimethoxysilane (MPTMS), but are not limited thereto. In addition, the surface treatment agent may include dimethyldimethoxysilane (DMDMS), methyltrimethoxysilane (MTMS), methyltriethoxysilane (MTES), or tetraethoxysilane (TEOS). In the present application, the surface of the inorganic particles may be treated with one type of surface treatment agent, or the surface may be treated with two different types of surface treatment agents. In addition, the inorganic particles may be included in an amount of 1 to 20 parts by weight based on 100 parts by weight of the polyamic acid. A lower limit of the content may be, for example, 3 parts by weight, 5 parts by weight, 8 parts by weight, 9 parts by weight, or 10 parts by weight or more, and an upper limit may be, for example, 18 parts by weight, 15 parts by weight, 13 parts by weight, or 8 parts by weight or less. In the present application, by blending the inorganic particles into the polyamic acid composition, dispersibility and miscibility may be improved, and adhesiveness and heat-resistant durability after curing may be realized.

The polyamic acid composition may have a coefficient of thermal expansion (GTE) of 40 ppm/° C. or less after curing. For example, an upper limit of the CTE may be 40 ppm/° C., 35 ppm/° C., 30 ppm/° C., 25 ppm/° C., 20 ppm/° C., 18 ppm/° C., 15 ppm/° C., 13 ppm/° C., 10 ppm/° C., 8 ppm/° C., 7 ppm/° C., 6 ppm/° C., 5 ppm/° C., 4.8 ppm/° C., 4.3 ppm/° C., 4 ppm/° C., 3.7 ppm/° C., 3.5 ppm/° C., 3 ppm/° C., 2.8 ppm/° C., or 2.6 ppm/° C. or less, and a lower limit may be, for example, 0.1 ppm/° C., 1 ppm/° C., 2.0 ppm/° C., 2.6 ppm/° C., 2.8 ppm/° C., 3.5 ppm/° C., or 4 ppm/° C. or more. In one example, the coefficient of thermal expansion may be measured at 100 to 450° C. For the CTE, the thermomechanical analyzer Q400 model from TA Instruments, Inc. may be used, and after cutting the prepared polyimide film to a width of 2 mm and a length of 10 mm, the temperature may be raised from room temperature to 500° C. at a rate of 10° C./min while applying a tensile force of 0.05 N under a nitrogen atmosphere, and then the slope of the section from 100° C. to 450° C. may be measured while cooling at a rate of 10° C./min.

In addition, the polyamic acid composition may have an elongation of 10% or more after curing, and in specific examples, 12% or more, 13% or more, 15% or more, 18% or more, 20 to 60%, 20 to 50%, 20 to 40%, 20 to 38%, 22 to 36%, 24 to 33%, or 25 to 29%. The elongation may be measured by the ASTM D-882 method using the Instron5564 UTM equipment from Instron Corp., after the polyamic acid composition is cured to form a polyimide film, and cut to a width of 10 mm and a length of 40 mm.

In addition, the polyamic acid composition of the present application may have an elastic modulus after curing in a range of 6.0 GPa to 11 GPa. A lower limit of the elastic modulus may be, for example, 6.5 GPa, 7.0 GPa, 7.5 GPa, 8.0 GPa, 8.5 GPa, 9.0 GPa, 9.3 GPa, 9.55 GPa, 9.65 GPa, 9.8 GPa, 9.9 GPa, 9.95 GPa, 10.0 GPa, or 10.3 GPa or more, and an upper limit may be, for example, 10.8 GPa, 10.5 GPa, 10.2 GPa, or 10.0 GPa or less. In addition, the polyamic acid composition may have a tensile strength in a range of 300 MPa to 600 MPa after curing. The lower limit of the tensile strength may be, for example, 350 MPa, 400 MPa, 450 MPa, 480 MPa, 500 MPa, 530 MPa, or 540 MPa or more, and an upper limit may be, for example, 580 MPa, 570 MPa, 560 MPa, 545 MPa, 530 MPa, or 500 MPa or less. The elastic modulus and tensile strength may be measured according to the ASTM D-882 method using Instron 5564 UTM equipment manufactured by Instron Corp after curing the polyamic acid composition to form a polyimide film, then cutting it to a width of 10 mm and a length of 40 mm. At this time, the cross head speed used for measurement may be 50 mm/min.

In one example, the polyamic acid composition according to the present application may have a glass transition temperature of 350° C. or more after curing. An upper limit of the glass transition temperature may be 800° C. or 700° C. or less, and a lower limit may be 360° C., 365° C., 370° C., 380° C., 390° C., 400° C., 410° C., 420° C., 425° C., 430° C., 440° C., 445° C., 448° C., 450° C., 453° C., 455° C., or 458° C. or more. The glass transition temperature may be measured at 10° C./min using TMA for the polyimide prepared by curing the polyamic acid composition.

The polyamic acid composition according to the present application may have a 1% by weight thermal decomposition temperature of 500° C. or more after curing. The thermal decomposition temperature may be measured using the thermogravimetric analyzer Q50 model from TA Instruments, Inc. In an embodiment, the polyimide obtained by curing the polyamic acid is heated to 150° C. at a rate of 10° C./min in a nitrogen atmosphere and then an isothermal temperature is maintained for 30 min to remove moisture. Thereafter, the temperature is increased to 600° C. at a rate of 10° C./min, and the temperature at which a weight loss of 1% occurs may be measured. A lower limit of the thermal decomposition temperature may be, for example, 510° C., 515° C., 518° C., 523° C., 525° C., 528° C., 530° C., 535° C., 538° C., 545° C., 550° C., 560° C., 565° C., 568° C., 570° C., 580° C., 583° C., 585° C., 588° C., 590° C., or 593° C. or more, and an upper limit may be, for example, 800° C., 750° C., 700° C., 650° C., or 630° C. or less.

In addition, the polyamic acid composition according to the present application may have light transmittance in the range of 50 to 80% in any one wavelength band of a visible light region (380 to 780 nm) after curing. A lower limit of the light transmittance may be, for example, 55%, 58%, 60%, 62%, 63%, 64%, 65%, 66%, 67%, 68%, 69%, 70%, or 71% or more, and the upper limit may be, for example, 78%, 75%, 73%, 72%, 71%, 69%, 68%, 67%, 66%, 65%, or 64% or less.

In addition, the present application relates to a method of preparing a polyamic acid composition.

The above preparation method is a method of preparing a polyamic acid composition including a polyamic acid containing a dianhydride monomer component and a diamine monomer component as polymerization units, and an organic solvent including at least a polar functional group, and may include heating at a temperature of at least 50° C. or more. A lower limit of the heating temperature may be, for example, 55° C. or more, 58° C. or more, 60° C. or more, 63° C. or more, 65° C. or more, or 68° C. or more, and an upper limit may be, for example, 100° C. or less, 98° C. or less, 93° C. or less, 88° C. or less, 85° C. or less, 83° C. or less, 80° C. or less, 78° C. or less, 75° C. or less, 73° C. or less, or 71° C. or less. The present application may include mixing an organic solvent and a dianhydride monomer component prior to the heating step. In the present application, the above-described heating step may be performed after the mixing, and thus heating may be performed in a state in which the organic solvent and the dianhydride monomer are included. In the present application, a desired polyamic acid structure can be obtained by performing a heating step at a higher temperature than the existing process, and an overall polymer chain length after curing can be increased, and this polymer can realize excellent heat resistance, dimensional stability, and mechanical properties.

In an embodiment, the method of preparing the polyamic acid composition of the present application may have, for example, the following polymerization method.

Examples of this method are: (1) a method in which the total amount of the diamine monomer is put in a solvent, and then the dianhydride monomer is added to be substantially equimolar with the diamine monomer and polymerized;
(2) a method in which the total amount of the dianhydride monomer is put in a solvent, and then the diamine monomer is added to be substantially equimolar with the dianhydride monomer and polymerized;
(3) a method in which some of the diamine monomer components are put in a solvent, then some of the dianhydride monomer components are mixed at a ratio of about 95 to 105 mol % with respect to the reaction components, then the remaining diamine monomer components are added thereto, subsequently the remaining dianhydride monomer components are added, and polymerization is carried out in such a manner that a diamine monomer and a dianhydride monomer are substantially equimolar,
(4) a method in which, after a dianhydride monomer is put in a solvent, some of the diamine compound components are mixed with respect to the reaction components, other dianhydride monomer components are added, the remaining diamine monomer components are added, and polymerization is carried out in such a manner that a diamine monomer and a dianhydride monomer are substantially equimolar, and
(5) a method in which some diamine monomer components and some dianhydride monomer components, in which either one is in excess, are reacted in a solvent to form a first composition, some of diamine monomer components and some the dianhydride monomer components, in which either one is in excess, are reacted in another solvent to form a second composition, and then the first and second compositions are mixed to complete polymerization, wherein, when the diamine monomer component is excessive when forming the first composition, the dianhydride monomer component is excessive in the second composition, and when the dianhydride monomer component is excessive in the first composition, the diamine monomer component is excessive in the second composition, and the first and second compositions are mixed so that all of the diamine monomer components and dianhydride monomer components used in these reactions are substantially equimolar.

The polymerization method is not limited to the above examples, and any known method may be used.

The preparation of the polyamic acid composition may be performed at 30 to 80° C.

In addition, the present application relates to a polyimide including a cured product of the polyamic acid composition. In addition, the present application provides a polyimide film including the polyimide. The polyimide film may be a polyimide film for a substrate, and in specific examples, may be a polyimide film for a TFT substrate.

In addition, the present invention provides a method of preparing a polyimide film, including forming a film of the polyamic acid composition prepared according to the method of preparing the polyamic acid composition on a support and drying the film to prepare a gel film, and curing the gel film.

In the method of preparing a polyimide film of the present invention, the steps of forming a film of the polyimide precursor composition on a support, drying the film to prepare a gel film, and curing the gel film may be performed through the following process: drying the polyimide precursor composition formed on the support at a temperature of 20 to 120° C. for 5 to 60 minutes to prepare a gel film, increasing the temperature of the gel film to 30 to 500° C. at a rate of 1 to 8° C./min, heat-treating the film at 450 to 500° C. for 5 to 60 minutes, and cooling the resulting film to 20 to 120° C. at a rate of 1 to 8° C./min.

The step of curing the gel film may be performed at 30 to 500° C. For example, the step of curing the gel film may be performed at 30 to 400° C., 30 to 300° C., 30 to 200° C., 30 to 100° C., 100 to 500° C., 100 to 300° C., 200 to 500° C., or 400 to 500° C.

A thickness of the polyimide film may be 10 to 20 μm. For example, a thickness of the polyimide film may be 10 to 18 μm, 10 to 16 μm, 10 to 14 μm, 12 to 20 μm, 14 to 20 μm, 16 to 20 μm, or 18 to 20 μm.

The support may be, for example, an inorganic substrate, and examples of the inorganic substrate include a glass substrate and a metal substrate, but it is preferable to use a glass substrate, and as the glass substrate, a soda-lime glass, a borosilicate glass, or an alkali-free glass may be used, but is not limited thereto.

### Advantageous Effects

The present application relates to a polyamic acid composition, and more specifically, to a polyamic acid composition which has a high solid content of polyamic acid, low viscosity, and excellent heat resistance, dimensional stability and mechanical properties after curing, and a polyimide and a polyimide film prepared therefrom.

### [Best Mode for Implementation of the Invention]

Hereinafter, the present invention will be described in more detail through examples according to the present invention and comparative examples not according to the present invention, but the scope of the present invention is not limited by the examples presented below.

<Preparation of polyamic acid solution>

### Example 1

N-methyl-pyrrolidone (NMP, 99.95% by weight) was input as the first solvent while nitrogen was input into a 500 ml reactor equipped with a stirrer and a nitrogen inlet and outlet tube, and then a second solvent, methanol (MeOH), was added at a rate of 0.05% by weight as an additional solvent and stirred. After setting the temperature of the reactor to 70° C., biphenyltetracarboxylic dianhydride (BPDA) was input as a dianhydride monomer to react. Subsequently, p-phenylene diamine (PPD) was completely dissolved in the reaction solution as a diamine monomer by lowering the temperature to 30° C. under a nitrogen atmosphere and rapidly stirred. Thereafter, stirring was continued for 120 minutes while heating to 40° C. to prepare a polyamic acid solution.

### Example 2

A polyamic acid solution was prepared in the same manner as in Example 1, except that an added solvent type and a content ratio were adjusted as shown in Table 1.

### Examples 3 and 4

A polyamic acid solution was prepared in the same manner as in Example 1, except that a monomer, an added solvent type, and a content ratio were adjusted as shown in Table 1.

### Comparative Example 1

A polyamic acid solution was prepared in the same manner as in Example 1 except for an added solvent.

### Comparative Example 2

A polyamic acid solution was prepared in the same manner as in Example 1, except that an added solvent type was changed to acetone.

### Comparative Example 3

A polyamic acid solution was prepared in the same manner as in Example 3, except that an added solvent type was changed to toluene.

### Comparative Example 4

A polyamic acid solution was prepared in the same manner as in Example 4, except that an added solvent type was changed to methyl ethyl ketone.

### Comparative Example 5

A polyamic acid solution was prepared in the same manner as in Example 4, except that an added solvent type was changed to acetonitrile.

### Comparative Example 6

A polyamic acid solution was prepared in the same manner as in Example 1, except that an added solvent type was changed to hexane.

TABLE 1

| | Diamine | Dianhydride | | |
|---|---|---|---|---|
| | PPD | BPDA | PMDA | |
| | (mol %) | (mol %) | (mol %) | Additional added solvent |
| Example 1 | 100 | 100 | — | MeOH (0.05% by weight) |
| Example 2 | 100 | 100 | | EtOH (0.1% by weight) |
| Example 3 | 100 | 70 | 30 | EA (0.5% by weight) |
| Example 4 | 100 | 50 | 50 | DME (1% by weight) |
| Comparative | 100 | 100 | — | — |
| Example 1 | | | | |
| Comparative | 100 | 100 | — | Acetone (0.1% by weight) |
| Example 2 | | | | |
| Comparative | 100 | 70 | 30 | Toluene (0.1% by weight) |
| Example 3 | | | | |
| Comparative | 100 | 50 | 50 | MEK (0.5% by weight) |
| Example 4 | | | | |
| Comparative | 100 | 50 | 50 | AN (1% by weight) |
| Example 5 | | | | |
| Comparative | 100 | 100 | | Hexane (1% by weight) |
| Example 6 | | | | |

PPD: p-Phenylene diamine
BPDA: Biphenyltetracarboxylic dianhydride
PMDA: Pyromellitic dianhydride
MeOH: Methanol
EtOH: Ethanol
EA: Ethyl acetate
DME: 1,2-dimethoxyethane
MEK: Methyl ethyl ketone
AN: Acetonitrile

### <Preparation of Polyimide for Measurement of Physical Properties>

Bubbles were removed from the polyamic acid compositions prepared in the examples and comparative examples through high-speed rotation at 1,500 rpm or more. Thereafter, the defoamed polyamic acid composition was applied to a glass substrate using a spin coater. Thereafter, a gel film was prepared by drying at a temperature of 120° C. in a nitrogen atmosphere for 30 minutes, and the temperature of the gel film was raised to 450° C. at a rate of 2° C./min, and after heat treatment at 450° C. for 60 minutes, cooled to 30° C. at a rate of 2° C./min to obtain a polyimide film. Thereafter, the polyimide film was peeled off the glass substrate by dipping it in distilled water. The physical properties of the prepared polyimide film were measured using the following methods, and the results are shown in Table 2 below.

### Experimental Example 1—Thickness

The thickness of the prepared polyimide film was measured using an electric film thickness tester manufactured by Anritsu Corp.

### Experimental Example 2—Viscosity

For the polyimide precursor compositions prepared in the examples and comparative examples, viscosity was measured at a shear rate of 1/s, a temperature of 23° C., and a plate gap of 1 mm using a Rheostress 600 manufactured by Haake GmbH.

### Experimental Example 3—CTE

The thermomechanical analyzer Q400 model from TA Instruments, Inc. was used, and after cutting a polyimide film to a width of 2 mm and a length of 10 mm, the temperature was raised from room temperature to 500° C. at a rate of 10° C./min while applying a tensile force of 0.05 N under a nitrogen atmosphere, and then the slope of the section from 100° C. to the Tg temperature was measured while cooling at a rate of 10° C./min.

### Experimental Example 4—Glass Transition Temperature

For the polyimide films prepared in the examples and comparative examples, the point at which the polyimide film rapidly expanded under a 10° C./min condition was measured as the on-set point using TMA.

### Experimental Example 6—Elongation

After cutting a polyimide film to a width of 10 mm and a length of 40 mm, an elongation was measured by the ASTM D-882 method using the Instron5564 UTM equipment from Instron Corp.

### Experimental Example 6—Elastic Modulus and Tensile Strength

After cutting a polyimide film to a width of 10 mm and a length of 40 mm, a modulus and a tensile strength were measured by the ASTM D-882 method using the Instron5564 UTM equipment from Instron Corp. At this time, the cross head speed used for measurement was 50 mm/min.

### Experimental Example 7—Film Appearance

The polyimide films prepared in the examples and comparative examples were visually inspected, and classified as 0 when the appearance was good without bubbles inside the film, X when a large number of bubbles occurred (3 or more), and E when there were 2 or less bubbles.

TABLE 2

| | | | | | | Elastic | Tensile | |
|---|---|---|---|---|---|---|---|---|
| | Thickness | Viscosity | CTE | g | Elongation | modulus | strength | Film |
| | (μm) | (cP) | (ppm/° C.) | (° C.) | (%) | (GPa) | (MPa) | condition |
| Example 1 | 10.3 | 5,100 | 3.8 | 60 | 37 | 9.6 | 550 | ◯ |
| Example 2 | 10.1 | 8,000 | 4.5 | 55 | 35 | 9.7 | 535 | ◯ |
| Example 3 | 10.5 | 4,800 | 2.7 | 50 | 30 | 10.1 | 510 | ◯ |
| Example 4 | 10.0 | 7,900 | 2.5 | 50 | 25 | 10.4 | 476 | ◯ |
| Comparative | 10.0 | 33,000 | 33 | 30 | 13 | 8.1 | 230 | ◯ |
| Example 1 | | | | | | | | |
| Comparative | 10.1 | 45,000 | 42 | 35 | 12 | 7.9 | 215 | Δ |
| Example 2 | | | | | | | | |
| Comparative | 10.3 | 18,000 | 25 | 70 | 7 | 8.5 | 257 | X |
| Example 3 | | | | | | | | |
| Comparative | 10.0 | 15,000 | 11 | 20 | 8 | 8.9 | 268 | Δ |
| Example 4 | | | | | | | | |
| Comparative | 11.0 | 22,000 | 40 | 26 | 8 | 7.5 | 202 | ◯ |
| Example 5 | | | | | | | | |
| Comparative | 11.0 | 51,000 | 48 | 16 | 5 | 6.5 | 180 | X |
| Example 6 | | | | | | | | |

1. A polyamic acid composition comprising:
a polyamic acid including a dianhydride monomer component and a diamine monomer component as polymerization units; and
an organic solvent including a first solvent and a second solvent,
wherein the second solvent has at least one polar functional group selected from the group consisting of a hydroxyl group, a carboxyl group, an alkoxy group, an ester group, and an ether group, and
the first solvent is a component different from the second solvent.

2. The polyamic acid composition of claim 1, wherein the second solvent is included in an amount of 0.01% by weight to 10% by weight in the entire polyamic acid composition.

3. The polyamic acid composition of claim 1, wherein the dianhydride monomer includes a monomer having an unpolymerized ring-opened structure in addition to the monomer included in the polymerization unit.

4. The polyamic acid composition of claim 3, wherein the dianhydride monomer having a ring-opened structure participates in an imidation reaction.

5. The polyamic acid composition of claim 1, wherein the diamine monomer includes 1,4-diaminobenzene (PPD), 1,3-diaminobenzene (MPD), 2,4-diaminotoluene, 2,6-diaminotoluene, 4,4′-diaminodiphenyl ether (ODA), 4,4′-methylenediamine (MDA), 4,4-diaminobenzanilide (4,4-DABA), N,N-bis(4-aminophenyl)benzene-1,4-dicarboxamide (BPTPA), 2,2-dimethylbenzidine (M-TOLIDINE), or 2,2-bis(trifluoromethyl)benzidine (TFDB).

6. The polyamic acid composition of claim 1, wherein the dianhydride monomer includes pyromellitic dianhydride (PMDA), 3,3′,4,4′-biphenyltetracarboxylic dianhydride (s-BPDA), 2,3,3′,4′-biphenyltetracarboxylic dianhydride (a-BPDA), 3,3′,4,4′-benzophenonetetracarboxylic dianhydride (BTDA), oxydiphthalic dianhydride (ODPA), 4,4-(hexafluoroisopropylidene)diphthalic anhydride (6-FDA), or p-phenylenebis(trimellitate anhydride) (TAHQ).

7. The polyamic acid composition of claim 1, wherein the first solvent has a higher boiling point than the second solvent.

8. The polyamic acid composition of claim 1, wherein a solid content is included in an amount of 9 to 35% by weight.

9. The polyamic acid composition of claim 1, wherein a viscosity measured at a temperature of 23° C. and a shear rate of 1 s⁻¹ is in a range of 500 to 50,000 cP.

10. The polyamic acid composition of claim 1, wherein a weight average molecular weight is in a range of 10,000 g/mol to 500,000 g/mol.

11. The polyamic acid composition of claim 1, further comprising inorganic particles.

12. The polyamic acid composition of claim 1, having a CTE of 40 ppm/° C. or less after curing.

13. The polyamic acid composition of claim 1, having a glass transition temperature of 350° C. or more after curing.

14. The polyamic acid composition of claim 1, wherein an elongation after curing is in a range of 10% or more.

15. The polyamic acid composition of claim 1, wherein an elastic modulus after curing is in a range of 6.0 GPa to 11 GPa.

16. The polyamic acid composition of claim 1, wherein a tensile strength after curing is in a range of 300 MPa to 600 MPa according to ASTM D-882.

17. A method of preparing the polyamic acid composition of claim 1, comprising heating at a temperature of at least 50° C. or more.

18. A polyimide comprising a cured product of the polyamic acid composition of claim 1.

19. A polyimide film for a substrate, comprising the polyimide of claim 18.
